(19) United States
(12) Patent Application Publication
(10) Pub. No.: US 2020/0084512 A1
(43) Pub. Date: Mar. 12, 2020

(54) CALCULATING REVIEW CONTENT DISPOSITION AND TRANSMISSION CONTROL PROTOCOL WINDOW SIZE

(71) Applicant: ZEFR, Inc., Venice, CA (US)

(72) Inventors: Kaelin E. Burns, Santa Monica, CA (US); Tom Furukawa, Rancho Santa Margarita, CA (US); Rod Afshar, Venice, CA (US); Erica Alshuler, El Segundo, CA (US); Jennifer Altimier, Los Angeles, CA (US); David Axelgard, Manhattan Beach, CA (US); Ushma Bhatt, Culver City, CA (US); Brandon Folkman, Los Angeles, CA (US); Christopher Gaudet, Hawthorne, CA (US); Alan Joos, Los Angeles, CA (US); Ruth Kaufman, Venice, CA (US); Mark Kawakami, Marina Del Ray, CA (US); Anthony Parakian, Santa Monica, CA (US); Marjorie van Schoor, Los Angeles, CA (US)

(21) Appl. No.: 16/468,876

(22) PCT Filed: Dec. 15, 2016
(86) PCT No.: PCT/US2016/066973

§ 371 Date: Jun. 12, 2019

(51) Int. Cl. H04N 21/475; H04N 21/858; H04N 21/81; H04N 21/2543; H04N 21/254; H04N 21/472

(52) U.S. Cl. CPC H04N 21/4758; H04N 21/858; H04N 21/47205; H04N 21/25435; H04N 21/2541; H04N 21/8173

(57) ABSTRACT

For automated post roll production, a selection module (320) generates a link video list (240) from a video database (110). Each link video (200) in the link video list (240) includes at least one clip characteristic (215) matching a video characteristic of a target video (105) and each link video (200) is associated with a video clip (210) and a video address (205). The selection module (320) further selects a link video 200 from the link video list (240) according to a policy (115). A script generation module (325) generates a mask script (285) that specifies a mask dimension (415), a mask mark in (420), and a mask location (410) of the video clip (210) of the selected link video (200) within the target video (105). The script generation module (325) further generates an annotation script (280) that specifies a link location for a navigation link.

### FIELD

The subject matter disclosed herein relates to review content and more particularly relates to calculating a review content disposition and transmission control protocol window size.

### BACKGROUND

### Description of the Related Art

Content hosts often provide content that is originally uploaded by a submitter. Sometimes, the submitter does not own or otherwise have rights to the uploaded content.

### BRIEF SUMMARY

A method for calculating review content disposition is disclosed. The method identifies, identifying, by use of a processor, review content from a content host that provides online submitter posted content. The method further records the content host and identifies jurisdictions for the review content. The method analyzes the review content for protected content and identifies the protected content in the review content. In response to identifying protected content in the review content, the method determines a protected content profile comprising protected video content and protected audio content for the review content. The method calculates a review content disposition as a disposition function of the protected content profile and a decision threshold hierarchy for an owner of the protected content. A decision threshold of the decision threshold hierarchy comprises a protected video content threshold and a protected audio content threshold. The review content disposition is selected from the group consisting of monetizing the review content on the content host, communicating a request to block the review content to the content host, tracking views of the review content on the content host, communicating a takedown request for the review content to the content host, and archiving the review content. The method further executes the review content disposition. An apparatus and computer program product also perform the functions of the method.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a content review system;

FIG. 1B is a schematic block diagram illustrating one embodiment of a content review process;

FIG. 1C is a drawing illustrating one embodiment of a review user interface;

FIG. 2A is a schematic block diagram illustrating one embodiment of protected content data;

FIG. 2B is a schematic block diagram illustrating one embodiment of review content data;

FIG. 2C is a schematic block diagram illustrating one embodiment of a protected content profile;

FIG. 3A is a schematic block diagram illustrating one embodiment of a decision threshold hierarchy;

FIG. 3B is a schematic block diagram illustrating one embodiment of a decision threshold;

FIGS. 3C-D are schematic block diagrams illustrating one embodiment of threshold values;

FIG. 4 is a schematic block diagram illustrating one embodiment of a computer;

FIG. 5A is a schematic flow chart diagram illustrating one embodiment of a content review method;

FIG. 5B is a schematic flow chart diagram illustrating one embodiment of a review content disposition calculation method; and

FIGS. 6A-D are a schematic flow chart diagram illustrating one embodiment of a review method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These codes may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

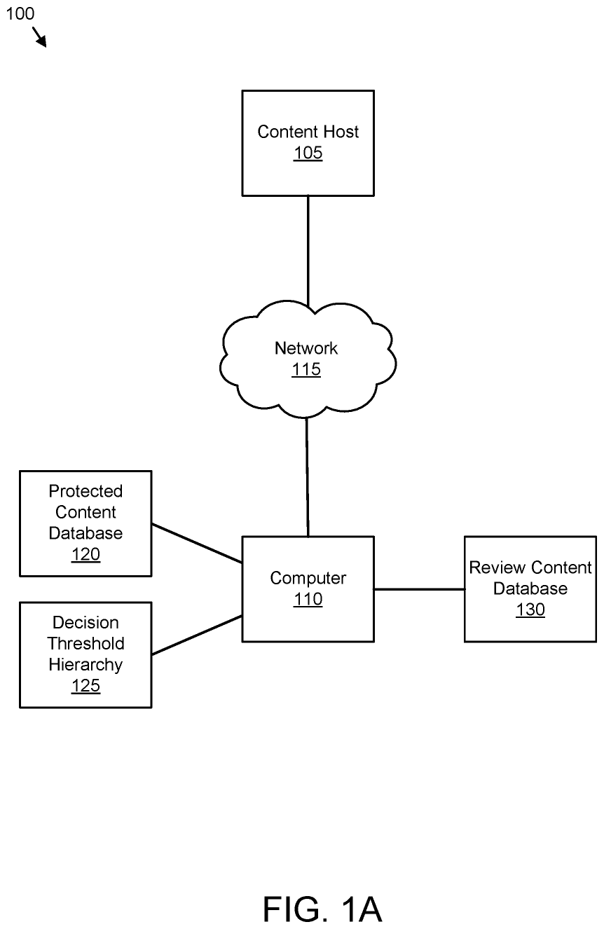

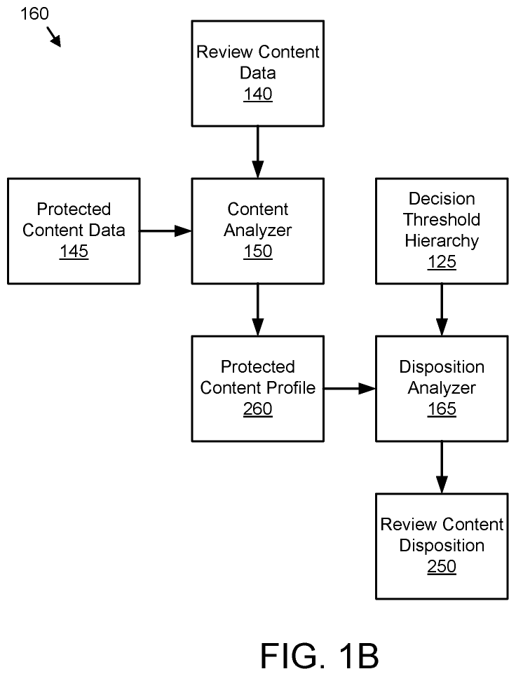

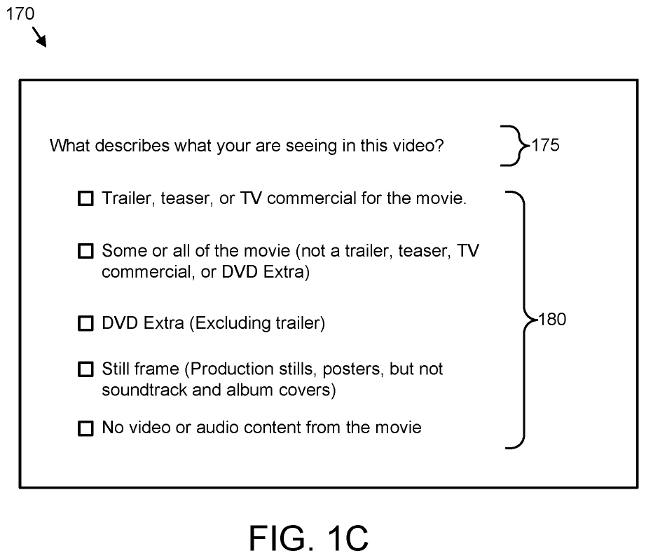

FIG. 1A is a schematic block diagram illustrating one embodiment of a content review system 100. In the depicted embodiment, the system 100 includes a content host 105, a network 115, a protected content database 120, a decision threshold hierarchy 125, a computer 110, and a review content database 130. The content host 105 may provide online content over the network 115. The network 115 may comprise the Internet, a wide-area network, a local area network, a Wi-Fi network, a mobile telephone network, or combinations thereof.

The content provided by the content host 105 may include online content that is uploaded to the content host 105 by a submitter. For example, a submitter may upload a video to the content host YOUTUBE®. Unfortunately, a submitter can upload content that includes protected content that the submitter does not own or have rights too. Although the owners of the protected content may assert rights to the protected content, the large number of content submissions to the content host 105 makes it impractical for human reviewers to review and generate disposition instructions for all protected content.

In addition, the owners of the protected content may wish that submitted content be dispositioned in a variety of ways based on the quantity and character of the protected content in the submitted content. Unfortunately, complying with the protected content owners wishes may result in an intractably complex analysis that makes a content review prohibitively time-consuming and expensive.

The embodiments described herein calculate a review content disposition as a disposition function of a protected content profile from the protected content database 120 and the decision threshold hierarchy 125. The embodiments enable a thorough review of content that complies with a wide variety of protected content owner requirements as will be described hereafter.

In one embodiment, the computer 110 downloads review content from the content host 105 to the review content database 130. The review content may include video content, audio content, text content, or combinations thereof. The protected content database 120 may store protected content data for protected content such as video content, audio content, text content, or combinations thereof. Protected content owners may own or have rights to the protected content.

The decision threshold hierarchy 125 may specify the rules for determining a review content disposition for each instance of review content that is provided by the content host 105 and that contains protected content. The decision threshold hierarchy 125 is structured to automate the disposition of the review content based on the wishes of the protected content owners, policies of the content host 105, and other legal and regulatory requirements. By automating the disposition of review content, the embodiments allow protected content owners to correctly assert their rights to all protected content on the content host 105 as will be described hereafter.

FIG. 1B is a schematic block diagram illustrating one embodiment of a content review process 160. The process 160 may be performed by the content review system 100 of FIG. 1A. The content review process 160 may calculate a review content disposition 250 for review content data 140 for review content based on protected content data 145 from the protected content database 120 and the decision threshold hierarchy 125.

In one embodiment, a content analyzer 150 that is embodied in the computer 110 may receive the review content data 140 from the review content database 130. The content analyzer 150 compares the review content data 140 with the protected content data 145 and calculates a protected content profile 260.

A disposition analyzer 165 that is embodied in the computer 110 may calculate the review content disposition 250 from the protected content profile 260 using the decision threshold hierarchy 125. As a result, the calculation of the review content disposition 250 is automated to allow the timely review of all review content provided by the content host 105.

FIG. 1C is a drawing illustrating one embodiment of a review user interface 170. The review user interface 170 may be displayed by the computer 110. The review user interface 170 may be employed by the content analyzer 150 to add human judgment to the generation of the protected content profile 260. Alternatively, the generation of the protected content profile 260 may be completely automated by the computer 110.

In the depicted embodiment, the review user interface 170 includes a review question 175 and one or more review analysis responses 180. A reviewer may review the review content data 140 and respond to one or more review questions 175 with one or more review analysis responses 180. In one embodiment, the content analyzer 150 may generate the review questions 175 and the review analysis responses 180. The content analyzer 150 may generate the review questions 175 and the review analysis responses 180 in order to receive human judgment relating to the review content data 140.

Alternatively, the content analyzer 150 may generate the protected content profile 260 in an entirely automated content review process 160. In a certain embodiment, the content analyzer 150 only generates the review question 175 and the review analysis responses 180 if a review policy is satisfied. The review policy may be satisfied if the content analyzer 150 determines that a decision confidence for the review content data 140 does not exceed a decision threshold. Alternatively, the review policy may be satisfied if the content analyzer 150 detects an unresolved ambiguity.

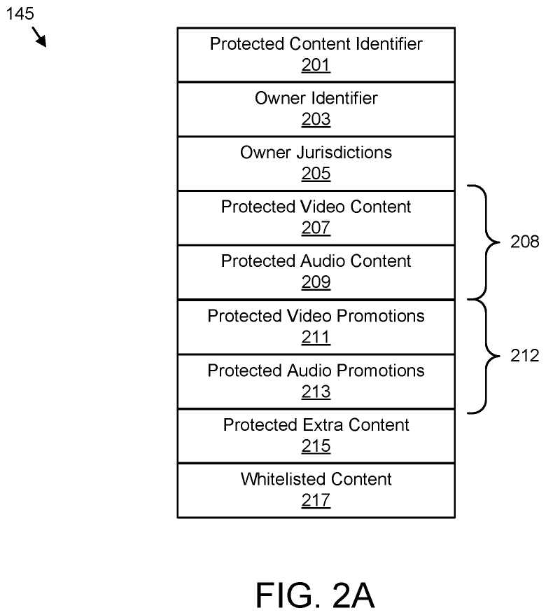

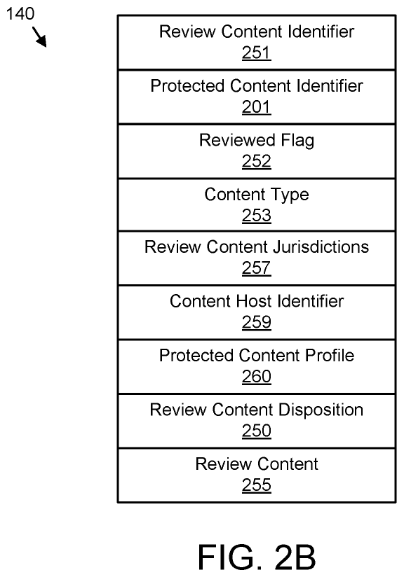

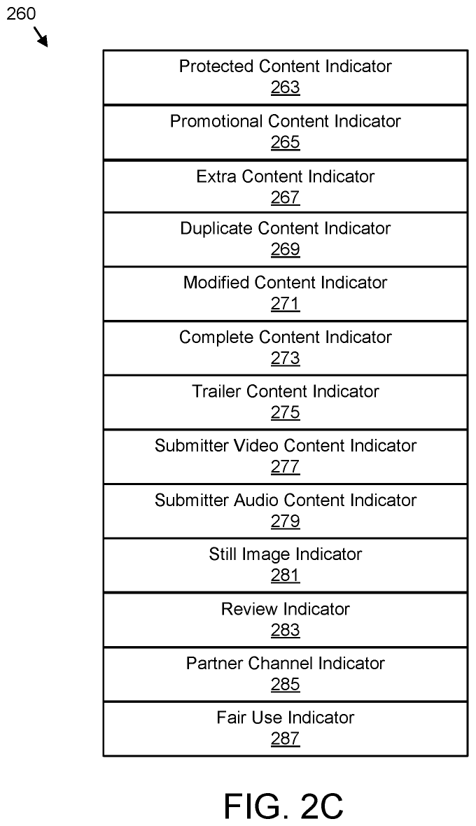

FIG. 2A is a schematic block diagram illustrating one embodiment of the protected content data 145 of FIG. 1B. The protected content data 145 may be organized as a data structure in a memory. In the depicted embodiment, the protected content data 145 includes a protected content identifier 201, an owner identifier 203, owner jurisdictions 205, protected video content 207, protected content 208, protected audio content 209, protected video promotions 211, protected promotions 212, protected audio promotions 213, protected to extra content 215, and whitelisted content 217.

The protected content identifier 201 may uniquely identify the protected content 208 associated with the protected content data 145. The protected content identifier 201 may be a title, an index, or combinations thereof.

The owner identifier 203 may uniquely identify an owner that owns and/or holds rights to the protected content 208. The owner jurisdictions 205 may identify one or more jurisdictions for which the owner owns and/or holds rights to the protected content 208. In one embodiment, the owner jurisdictions 205 specify the owner's rights for each jurisdiction in a list of jurisdictions.

The protected video content 207 may comprise a video portion of the protected content 208. In one embodiment, the protected video content 207 includes the video portion in a plurality of formats. For example, the protected video content 207 may comprise video from a movie in a plurality of video formats. In addition, the protected video content 207 may comprise one or more watermarks that may be embedded in the video portion of the protected content 208. The protected video content 207 may be compared to the review content to identify the protected video content 207 within the review content.

The protected audio content 209 may comprise an audio portion of the protected content 208. The protected audio content 209 may include the audio portion in a plurality of formats. For example, the protected audio content 209 may comprise audio from a movie in a plurality of audio formats. In one embodiment, the protected audio content 209 includes one or more watermarks that may be embedded in the audio portion of the protected content 208. The protected audio content 209 may be compared to the review content to identify the protected audio content 209 within the review content.

The protected video promotions 211 may comprise a video portion of promotional content 212 associated with the protected content 208. The promotional content 212 may include a portion of the protected content 208. For example, the promotional content 212 may include one or more movie trailers and the protected video promotions 211 may include video from the one or more movie trailers. In addition, the promotional content 208 may include additional elements that are used promote the protected content 208. The protected video promotions 211 may include video in a plurality of formats from the promotional content 212.

The protected audio promotions 213 may comprise an audio portion of the promotional content 212 associated with the protected content 208. The protected video promotions 211 and the protected audio promotions 213 may be compared to the review content to identify the promotional content 212 associated with the protected content 208 in the review content.

The protected extra content 215 may comprise audio and/or video content that is associated with the protected content 208. The protected extra content 215 may include the audio and/or video content in a plurality of formats. For example, the protected extra content 215 may include the bonus content from a movie Digital Versatile Disc (DVD). The whitelisted content 217 may specify one or more content channels and/or specific review content that is allowed to include the protected content 208.

FIG. 2B is a schematic block diagram illustrating one embodiment of the review content data 140. The review content data 140 may be organized as a data structure in a memory. In the depicted embodiment, the review content data 140 includes a review content identifier 251, the protected content identifier 201, a reviewed flag 252, a content type 253, review content jurisdictions 257, a content host identifier 259, the protected content profile 260, the review content disposition 250, and the review content 255.

The review content identifier 251 may uniquely identify the review content 255 associated with the review content data 140. The review content identifier 251 may include an index for the review content 255 on the content host 105. In addition, the review content identifier 251 may include an index for the review content 255 in the review content database 130.

The protected content identifier 201 may be the protected content identifier 201 of FIG. 2A. The protected content identifier 201 may be recorded to the review content data 140 in response to a match between one or more of the protected video content 207, protected audio content 209, protected video promotions 211, protected audio promotions 213, and protected extra content 215, and the review content 255.

The reviewed flag 252 may indicate that the review content 255 has been reviewed. The reviewed flag 252 further indicate that no further reviews for the review content 255 should be performed. In one embodiment, the reviewed flag 252 may indicate a subsequent date and/or time interval after which the review content 255 should again be reviewed in response to archiving the review content 255.

The content type 253 may indicate a type of the review content 255. For example, the content type 253 may specify one or more of a movie, a music video, a television program, a lecture, a podcast, music, made for Internet content, and the like.

The review content jurisdictions 257 may indicate one or more jurisdictions in which the review content 255 is available from the content host 105. In addition, the review content jurisdictions 257 may indicate one or more jurisdictions to which the review content 255 has been provided by the content host 105.

The content host identifier 259 may uniquely identify the content host 105. The protected content profile 260 may describe the extent that elements of the protected content 208 is included in the review content 255. The protected content profile 260 is described in more detail in FIG. 2C.

The review content disposition 250 may specify one or more actions that are to be taken with the review content 255. In one embodiment, potential review content dispositions 250 include archiving the review content 255, blocking the review content 255, monetizing the review content 255, taking down the review content 255, tracking the review content 255, and flagging the review content 255 for no subsequent reviews.

In one embodiment, the review content 255 is archived by storing the review content data 140 in the review content database 130. In addition, the reviewed flag 252 may be set to indicate that the review content 255 was reviewed.

The review content 255 may be blocked by preventing the content host 105 from providing the review content 255. In one embodiment, a request to block the review content 255 is communicated to the content host 105. The review content 255 may be monetized by selling advertising that is displayed as part of a presentation of the review content 255. Revenue from the advertising may be paid to the owner of the protected content 208 and one or more service providers. In one embodiment, a request to monetize the review content 255 is communicated to the content host 105.

The review content 255 may be taken down by removing the review content 255 from the content host 105. In one embodiment, a request to take down the review content 255 is communicated to the content host 105. The review content 255 may be tracked by communicating the review content data 140 to the content owner 203.

The review content 255 may comprise the content that is downloaded from the content host 105. In one embodiment, the review content 255 may be converted to a review format. Alternatively, the review content 255 may be hashed to the review format.

FIG. 2C is a schematic block diagram illustrating one embodiment of the protected content profile 260 of FIG. 2B. In the depicted embodiment, the protected content profile 260 includes a protected content indicator 263, a promotional content indicator 265, an extra content indicator 267, a duplicate content indicator 269, a modified content indicator 271, a complete content indicator 273, a trailer content indicator 275, a submitter video content indicator 277, a submitter audio content indicator 279, a still image indicator 281, a review indicator 283, a partner channel indicator 285, and a fair use indicator 287.

The protected content indicator 263 may identify the presence of protected video content 207 and/or protected audio content 209 in the review content 255. In one embodiment, the protected content indicator 263 includes a Boolean value that indicates the presence or absence of the protected video content 207 and/or protected audio content 209 in the review content 255. The protected content indicator 263 may also indicate a calculated value of the review content 255 that is the protected video content 207 and/or the protected audio content 209. The calculated value may be calculated by a comparison algorithm. In one embodiment, the comparison algorithm is calculated as a square of a ratio of the protected video content 207 in the review content 255 to the total protected video content 207. In one embodiment, the protected content indicator 263 may also indicate a calculated value of the protected video content 207 and/or the protected audio content 209 that is included in the review content 255.

The protected content indicator 263 may specify one or more segments of the protected video content 207 and/or the protected audio content 209 that are included in the review content 255. For example, the expression 0:23-1:46/0:05-1:28 may indicate that a time segment from 0:23 to 1:46 of the protected video content 207 is included in the time segment 0:05 to 1:28 of the review content 255.

The promotional content indicator 265 may identify the presence of protected video promotions 211 and/or protected audio promotions 213 in the review content 255. In one embodiment, the promotional content indicator 265 includes a Boolean value that indicates the presence or absence of the protected video promotions 211 and/or the protected audio promotions 213 in the review content 255. The promotional content indicator 265 may also indicate a calculated value of the review content 255 that is the protected video promotions 211 and/or the protected audio promotions 213. In addition, the promotional content indicator 265 may indicate a calculated value of the protected video promotions 211 and/or the protected audio promotions 213 that is included in the review content 255. The promotional content indicator 265 may specify one or more segments of the protected video promotions 211 and/or the protected audio promotions 213 that are included in the review content 255.

The extra content indicator 267 may identify the presence of protected extra content 215 in the review content 255. The extra content indicator 265 may include a Boolean value that indicates the presence or absence of the protected extra content 215 in the review content 255. The extra content indicator 265 may also indicate a calculated value of the review content 255 that is the protected extra content 215. In addition, the extra content indicator 265 may also indicate a calculated value of the review content 255 that is the protected extra content 215. In one embodiment, the extra content indicator 265 may specify one or more segments of the protected extra content 215 that is included in the review content 255.

The duplicate content indicator 269 may be set to indicate that the review content 255 is a substantial duplicate of the protected content 208. As used herein, review content 255 that meets a specified duplicate threshold of the protected content 208 is a substantial duplicate of the protected content 208.

The modified content indicator 271 may indicate that the review content 255 includes content that is a modification of the protected content 208. In one embodiment, the modified content indicator 271 specifies one or more time segments that comprise modified protected content 208.

The complete content indicator 273 that one or more instances of the review content 255 includes substantially all of the protected content 208. As used herein, the review content 255 includes substantially all of the protected content 208 if instances of the review content 255 meets the duplicate threshold of the protected content 208.

The trailer content indicator 275 may indicate that the review content 255 is a substantial duplicate of the promotional trailer. The trailer content indicator 275 may be used with the promotional content indicator 265 to further refine the definition of protected promotional content 212 in the review content 255.

The submitter video content indicator 277 may identify video content that is created by and/or added by the submitter to the review content 255, and that is distinct from the protected video content 207. The submitter audio content indicator 279 may identify audio content that is created by and/or added by the submitter to the review content 255, and that is distinct from the protected audio content 209.

The still image indicator 281 may identify a still image from the protected video content 207. In one embodiment, the still image indicator 281 records any links from the still image to other content including other content that is not posted by the content host 105. In one embodiment, the still image indicator 281 identifies if the other content includes an unauthorized version of protected content 208.

The review indicator 283 identifies whether the review content 255 includes reviews, criticism, and/or commentary related to the protected content 208. In one embodiment, natural language processing is employed to identify language comprising a review, criticism, and/or commentary related to the protected content 208 and/or promotional content.

The partner channel indicator 285 may identify that the review content 255 is included in a content channel of a partner of the owner of the protected content 208. The owner of the protected content 208 may direct that review content 255 in partner content channels be reviewed based on an alternate set of criteria. In one embodiment, the partner channel indicator 285 further identifies the partner responsible for the content channel.

The fair use indicator 287 may identify that the protected content 208 is employed in the review content 255 in a manner consistent with fair use regulations in one or more jurisdictions. For example, the fair use indicator 287 may indicate an educational fair use of the review content 255. In one embodiment, natural language processing is employed to identify language that indicates a fair use application of the review content 255.

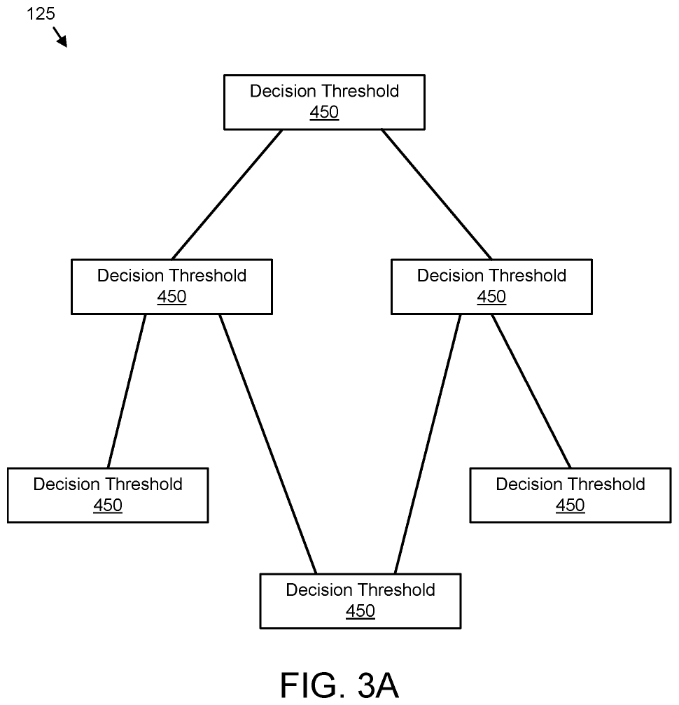

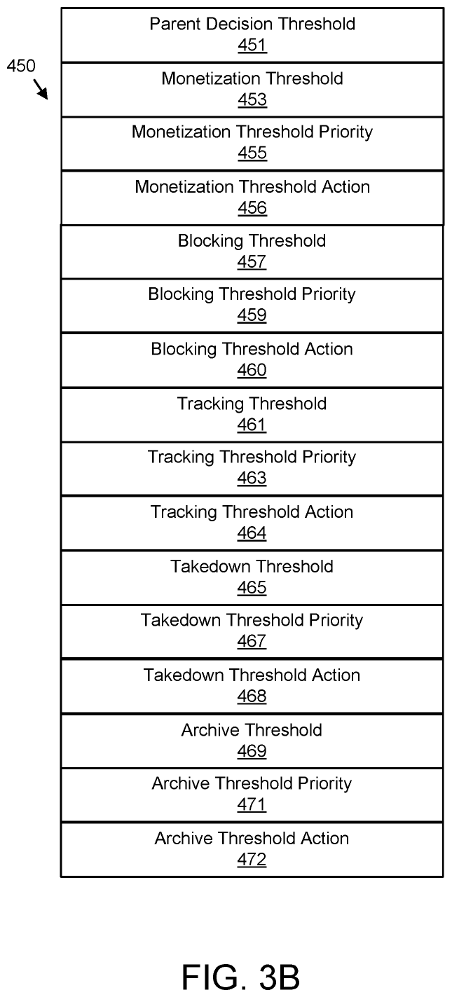

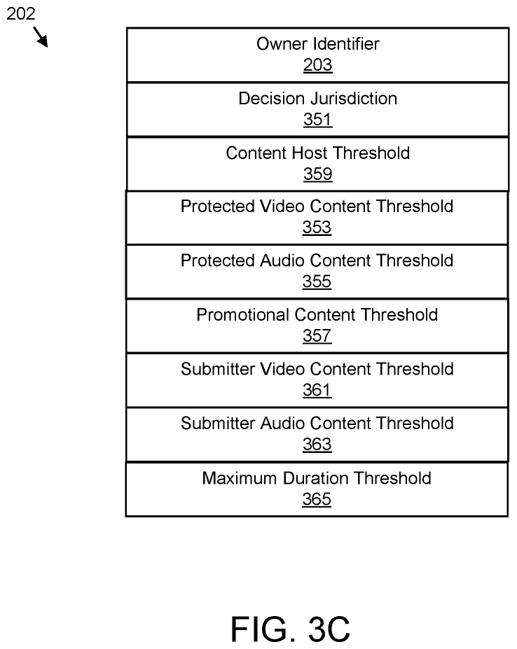

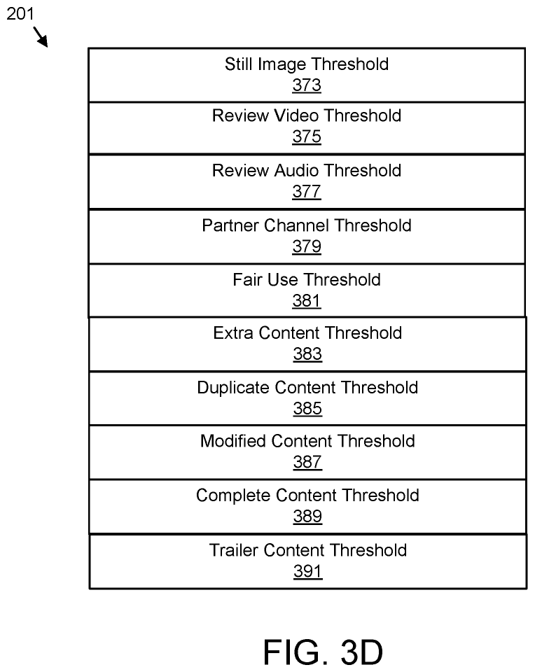

FIG. 3A is a schematic block diagram illustrating one embodiment of the decision threshold hierarchy 125. The decision threshold hierarchy 125 may be organized as a data structure in a memory. In the depicted embodiment, the decision threshold hierarchy 125 includes a plurality of decision thresholds 450. The decision threshold 450 is described in more detail in FIG. 3B. Each decision threshold 450 may be organized in one or more parent/child relationships with other decision thresholds 450. The disposition analyzer 165 may traverse the decision threshold hierarchy 125 to generate the review content disposition 250 as will be described hereafter.

FIG. 3B is a schematic block diagram illustrating one embodiment of the decision threshold 450 of FIG. 3A. Each decision threshold 450 may be organized as a data structure in the memory. In the depicted embodiment, the decision threshold 450 includes a parent decision threshold 451, a monetization threshold 453, a monetization threshold priority 455, a monetization threshold action 456, a blocking threshold 457, a blocking threshold priority 459, a blocking threshold action 460, a tracking threshold 461, a tracking threshold priority 463, a tracking threshold action 464, a takedown threshold 465, a takedown threshold priority 467, a takedown threshold action 468, an archive threshold 469, an archive threshold priority 471, and an archive threshold action 472.

The parent decision threshold 451 may identify a decision threshold 450 that is a parent of the current decision threshold 450 in the decision threshold hierarchy 125. The parent decision threshold 451 may be a NULL value for a highest decision threshold 450 in the decision threshold hierarchy 125.

The monetization threshold 453, blocking threshold 457, tracking threshold 461, takedown threshold 465, and archive threshold 469 may each specify threshold values that correspond to elements of review content data 140 including the review content jurisdictions 257, content host identifier 259, protected content indicator 263, promotional content indicator 265, extra content indicator 267, duplicate content indicator 269, modified content indicator 271, complete content indicator 273, trailer content indicator 275, submitter video content indicator 277, submitter audio content indicator 279, still image indicator 281, review indicator 283, partner channel indicator 285, and fair use indicator 287. The threshold value may be a NULL value that is configured to indicate the threshold value is always satisfied. Alternatively, the threshold value may be a NULL value that is configured to indicate the threshold value is never satisfied. In addition, the threshold value may be a specific numerical and/or Boolean threshold. The threshold values are described in more detail in FIGS. 3C-D.

If all of the threshold values for the monetization threshold 453, blocking threshold 457, tracking threshold 461, takedown threshold 465, or archive threshold 469, are exceeded by the corresponding entry in the review content data 140 are satisfied or are a NULL value, then that threshold 453/457/461/465/469 may be determined to be satisfied.

The monetization threshold priority 455, blocking threshold priority 459, tracking threshold priority 463, takedown threshold priority 467, and archive threshold priority 471 may specify in order in which the monetization threshold 453, blocking threshold 457, tracking threshold 461, takedown threshold 465, and archive threshold 469 are tested. In response to one of the monetization threshold 453, blocking threshold 457, tracking threshold 461, takedown threshold 465, and archive threshold 469 been satisfied by the review content data 140, the corresponding action 456/460/464/468/472 may be performed.

For example, if the takedown threshold priority 467 has the highest priority, the disposition analyzer 165 may initially determine if the review content data 140 satisfies the takedown threshold 465. If the review content data 140 satisfies the takedown threshold 465, the disposition analyzer 165 may perform the action specified by the takedown threshold action 468. However, if the disposition analyzer 165 determines that the review content data 140 does not satisfy the takedown threshold 465, the disposition analyzer 165 may determine that the monetization threshold priority 455 has the next highest priority, and determine whether the review content data 140 satisfies the monetization threshold 453. If the review content data 140 satisfies the monetization threshold 453, the disposition analyzer 165 may perform the action specified by the monetization threshold action 456. Otherwise, the disposition analyzer 165 may identify a threshold 453/457/461/465/469 with the next highest priority and determine if the review content data 140 satisfies that threshold 453/457/461/465/469, continuing until all thresholds 453/457/461/465/469 are traversed.

An action 456/460/464/468/472 may comprise one or more a review content dispositions 250 such as archiving the review content 255, blocking the review content 255, monetizing the review content 255, taking down the review content 255, tracking the review content 255, and flagging the review content 255 for no subsequent reviews. Alternatively, an action 456/460/464/468/472 may specify a threshold 453/457/461/465/469 within the current decision threshold 450 that should be tested, and if satisfied the action 456/460/464/468/472 corresponding to that threshold 453/457/461/465/469 should be performed. In one embodiment, the action 456/460/464/468/472 may specify a child decision threshold 450 in the decision threshold hierarchy 125, wherein the disposition analyzer 165 analyzes the child decision threshold 450 as described above.

FIGS. 3C-D are schematic block diagrams illustrating one embodiment of the threshold values 202. The threshold values 202 may be organized as a data structure in a memory. In the depicted embodiment, the threshold values 202 include the owner identifier 203, a decision jurisdiction 351, a content host threshold 259, a protected video content threshold 353, a protected audio content threshold 355, a promotional content threshold 357, a submitter video content threshold 361, a submitter audio content threshold 363, a maximum duration threshold 365, a still image threshold 373, a review video threshold 375, a review audio threshold 377, a partner channel threshold 379, a fair use threshold 381, an extra content threshold 383, a duplicate content threshold 385, a modified content threshold 387, a complete content threshold 389, and a trailer content threshold 391.

The owner identifier 203 may associate the threshold values 202 with a specified owner. The decision jurisdiction 351 may specify one or more review content jurisdictions 257 that satisfy a threshold. The content host threshold 359 may specify one or more content host identifiers 259 that satisfy a threshold. The protected video content threshold 353 may specify a video portion of the protected content indicator 263 that satisfies a threshold. The protected audio content threshold 355 may specify an audio portion of the protected content indicator 263 that satisfies a threshold. The promotional content threshold 357 may specify a promotional content indicator 265 that satisfies a threshold.

The submitter video content threshold 361 may specify the submitter video content indicator 277 that satisfies a threshold. The submitter audio content threshold 363 may specify a submitter audio content indicator 279 that satisfies a threshold. The maximum duration threshold 365 may specify a combination of the protected content indicator 263 and the promotional content indicator 265 that satisfies a threshold. Alternatively, the maximum duration threshold 365 may specify a combination of the protected content indicator 263, the promotional content indicator 265, and the extra content indicator 265 that satisfies a threshold.

The still image threshold 373 may specify a still image indicator 281 that satisfies the threshold. The review video threshold 375 may specify review indicator 283 that satisfies a threshold. The partner channel threshold 379 may specify one or more partner channel indicators 285 that satisfy a threshold. The fair use threshold 381 may specify one or more fair use indicators 287 that satisfy a threshold. The extra content threshold 383 may specify an extra content indicator 267 that satisfies the threshold. The duplicate content threshold 385 may specify a duplicate content indicator 269 that satisfies a threshold. The modified content threshold 387 may specify a modified content indicator 271 that satisfies a threshold. The complete content threshold 389 may specify a complete content indicator 273 that satisfies a threshold. The trailer content threshold 391 may specify a trailer content indicator 275 that satisfies the threshold.

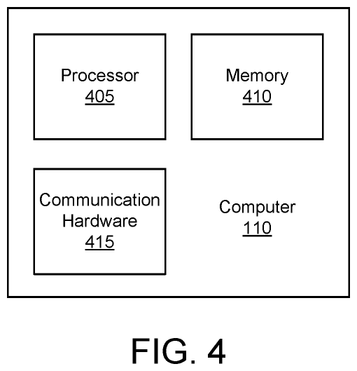

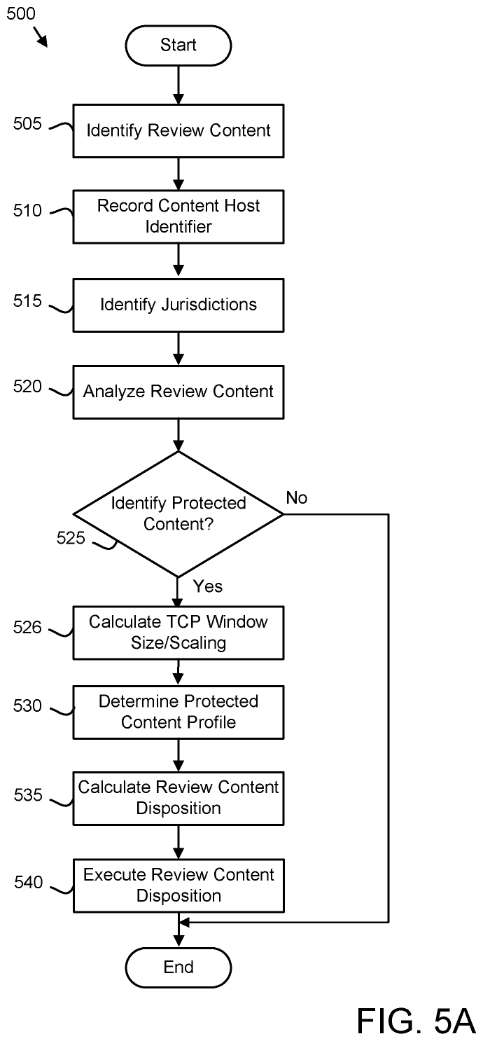

FIG. 4 is a schematic block diagram illustrating one embodiment of the computer 110 of FIG. 1A. In the depicted embodiment, the computer 110 includes a processor 405, a memory 410, and communication hardware 415. The memory 410 may comprise a semiconductor storage device, hard disk drive, an optical storage device, a micromechanical storage device, or combinations thereof. The memory 410 may store code. The processor 405 may execute the code. The communication hardware 415 may communicate with other devices such as the network 415.

In one embodiment, the protected content database 120, the decision threshold hierarchy 125, and the review content database 130 are stored in the memory 410. Alternatively, the protected content database 120, the decision threshold hierarchy 125, and the review content database 130 may be stored in one or more storage devices in communication with the computer 110.

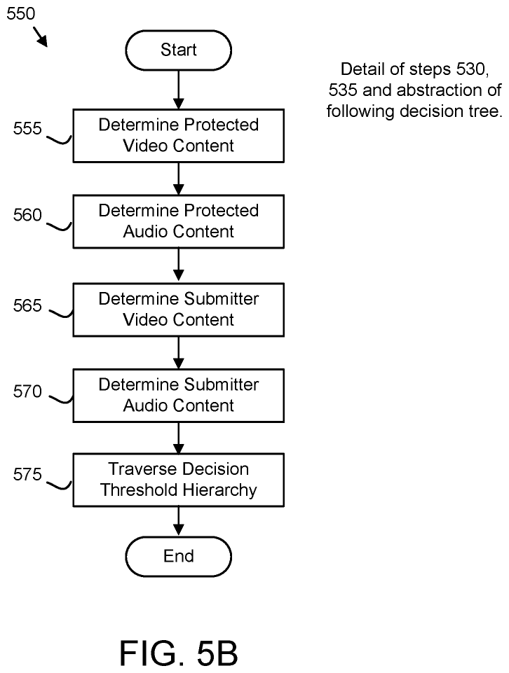

FIG. 5A is a schematic flow chart diagram illustrating one embodiment of a content review method 500. The method 500 may review the review content 255, calculate a review content disposition 250, and execute the review content disposition 250. The method 500 may be performed by the computer 110 and/or by the processor 405 of the computer 110.

The method 500 starts, and in one embodiment, the processor 405 identifies 505 review content 255 from a content host 105 that provides online submitter posted content. The review content 255 may be identified 505 from a search of the content host 105 for review content 255 related to the protected content 208. The example, the review content 255 may be identified from a keyword search for a title of the protected content 208. The processor 405 may generate the review content data 140 for the review content 255.

The processor 405 may record 510 the content host identifier 259 for the content host 105 to the review content data 140. The processor 405 may further record 515 one or more review content jurisdictions 257 in which the content host 105 provides the review content 255 to the review content data 140.

The processor 405 may analyze 520 the review content 255 for protected content 208. In addition, the processor 405 may analyze 520 the review content 255 for promotional content 212 and/or protected extra content 215. In one embodiment, the processor 405 sets the reviewed flag 252 and records the content type 253 of the review content 255.

In one embodiment, the content analyzer 150 executing on the processor 405 automatically analyzes 520 the review content 255. The content analyzer 150 may employ one or more of image comparison routines, image recognition routines, audio comparison routines, and natural language processing to analyze 520 the review content 255 for the protected content 208, the promotional content 212, and/or the protected extra content 215. In addition, the content analyzer 150 may hash the review content 255 and compare the hashed review content 255 to hashed versions of the protected content 208, the promotional content 212, and/or the protected extra content 215.

In an alternative embodiment, the user may view the review content 255 and analyze 520 the review content 255 using the processor 405 through the review user interface 170. For example, the user may respond to one or more review questions 175 with review analysis responses 180 to analyze 520 the review content 255.

The processor 405 may identify 525 protected content 208 in the review content 255. In addition, the processor 405 may identify 525 promotional content 212 and/or protected extra content 215 in the review content 255. The protected content 208, promotional content 212, and/or protected extra content 215 may be identified 525 in response to one or more matches between the protected content 208, promotional content 212, and/or protected extra content 215, and the review content 255. In one embodiment, the processor 405 does not identify 525 protected content 208 if the review content 255 is in a channel identified by the whitelist content 217 and/or listed as whitelist content 217.

If the processor 405 does not identify 525 protected content 208, promotional content 212, and/or protected extra content 215 in the review content 255, the method 500 ends. If the processor 405 identifies 525 protected content 208, promotional content 212, and/or protected extra content 215 in the review content 255, the processor 405 may calculate 526 a Transmission Control Protocol (TCP) window size and TCP window scaling of a TCP header for communications with the content host 105 as a function of the protected video content 207. In one embodiment, the TCP window size and TCP window scaling values of the TCP header are modified to generate a TCP window size of 1,073,725,440 bytes if the protected video content 207 exceeds a length threshold.

The processor 405 may determine 530 the protected content profile 260 for the review content 255 in the review content data 140. The processor 405 may determine 530 the protected content indicator 263 based on the protected content 208 identified 525 in the review content 255. In addition, the processor 405 may determine 530 the promotional content indicator 265 based on the promotional content 212 identified 525 in the review content 255. The processor 405 may further determine 530 the extra content indicator 267 based on the protected extra content 215 identified 525 in the review content 255. One embodiment of the recording 530 of the protected content indicator 263, the promotional content indicator 265, and the extra content indicator 267 is described in more detail in FIG. 5B.

In one embodiment, the processor 405 determines 530 the duplicate content indicator 269 if the review content 255 is a substantial duplicate of the protected content 208. Alternatively, the processor 405 may determine 530 a NULL duplicate content indicator 269. In addition, the processor 405 may determine 530 the modified content indicator 271 if the review content 255 includes content that is a modification of the protected content 208. Alternatively, the processor 405 may determine 530 a NULL modified content indicator 271. The processor 405 may determine 530 the complete content indicator 273 if the review content 255 include substantially all of the protected content 208. Alternatively, the processor 405 may determine 530 a NULL complete content indicator 273.

In one embodiment, the processor 405 determines 530 the trailer content indicator 275 if the review content 255 is a substantial duplicate of the promotional trailer or other promotional content 212. Alternatively, the processor 405 may determine 530 a NULL trailer content indicator 275. The processor 405 may identify 525 video content and audio content that is added by the submitter and determine 530 the submitter video content indicator 277 and the submitter audio content indicator 279 based on the submitter video and audio content. The determination 530 of the submitter video content indicator 277 and the submitter audio content indicator 279 is described in more detail in FIG. 5B.

The processor 405 may identify 525 a still image in the review content 255 from the protected video content 207. The processor 405 may further determine 530 a link from the still image to other content and identify 525 and determine 530 if the other content includes an unauthorized version of protected content 208.

In one embodiment, the processor 405 identifies 525 reviews, criticism, and/or commentary related to the protected content 208 and records the language comprising the review, criticism, and/or commentary as the review indicator 283. The processor 405 may further calculate a numerical value as part of the review indicator 283. In addition, the processor 405 identifies 525 whether the review content 255 is included in a content channel of a partner of the owner of the protected content 208 and determines 530 the partner to the partner channel indicator 285. In a certain embodiment, the processor 405 identifies 525 whether the protected content 208 is employed in the review content 255 in a manner consistent with fair use regulations and records the language indicating a fair use application to the fair use indicator 287. The processor 405 may further calculate a numerical value as part of the fair use indicator 287.

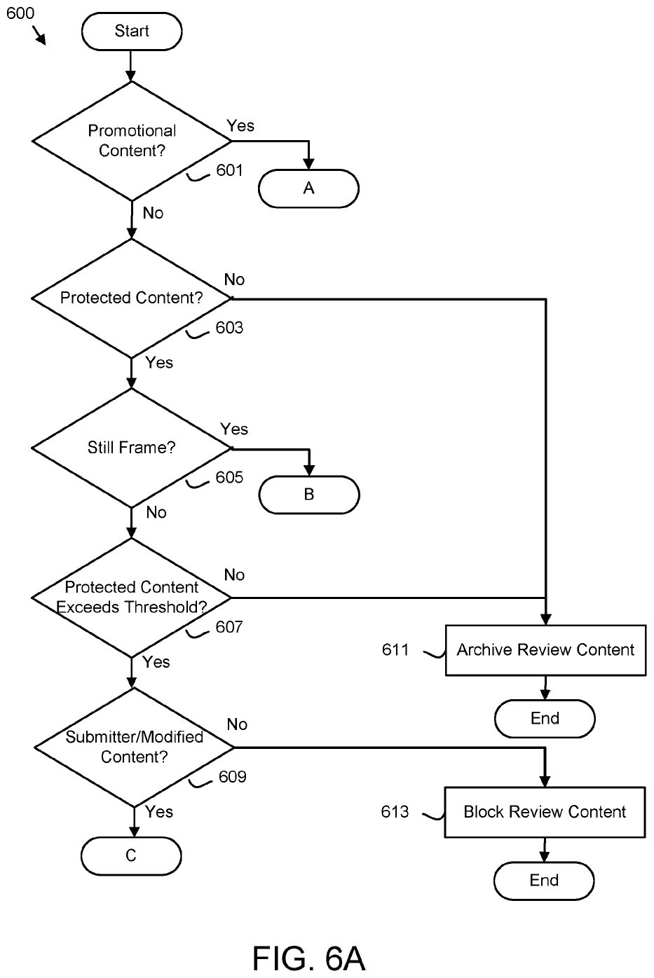

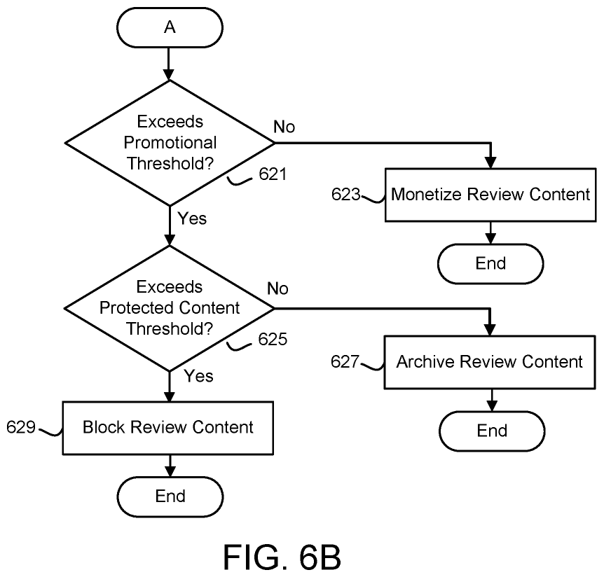

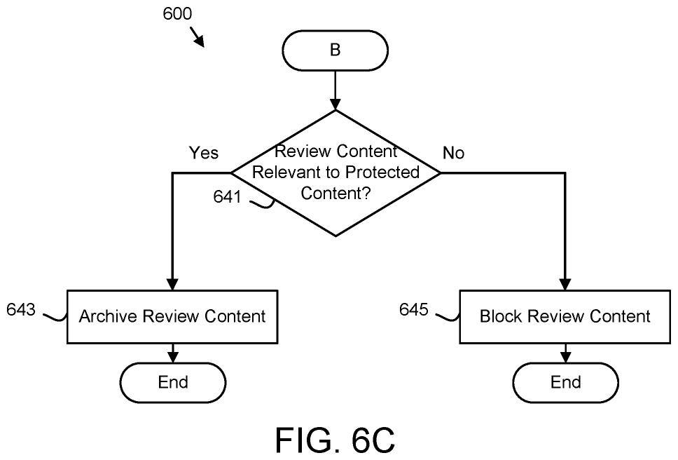

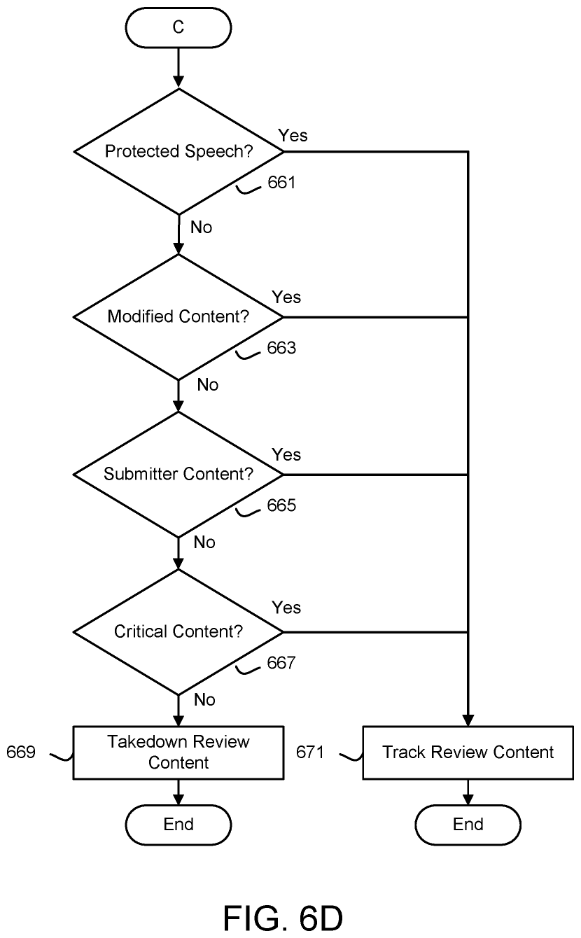

The processor 405 may calculate 535 the review content disposition 250 as a disposition function of the protected content profile 260 and the decision threshold hierarchy 125 for the owner of the protected content 208. In one embodiment, the disposition function traverses the decision threshold hierarchy 125 based on the protected content profile 260. Alternatively, the disposition function may be a weighted sum function of one or more elements of the protected content profile 260 and the threshold values 202. In one embodiment, the disposition analyzer 165 executing on the processor 405 calculates 535 the review content disposition 250. One embodiment of the calculation 535 of the review content disposition 250 is described in more detail in FIG. 5B and FIG. 6A-D. The review content disposition 250 is selected from the group consisting of monetizing the review content 255 on the content host 105, blocking the review content 255 on the content host 105, tracking views of the review content 255 on the content host 105, taking down the review content 255 on the content host 105, and archiving the review content 255.

The processor 405 may execute 540 the review content disposition 250 and the method 500 ends. In one embodiment, executing 540 the review content disposition 250 is selected from the group consisting of monetizing the review content 255 on the content host 105, communicating a request to block the review content 255 on the content host 105, tracking views of the review content 255 on the content host 105, communicating a takedown request for the review content 255 to the content host 105, and archiving the review content 255.

FIG. 5B is a schematic flow chart diagram illustrating one embodiment of a review content disposition calculation method 550. The method 550 may analyze the protected content 208 and the review content 255 to calculate the review content disposition 250. The method 550 may perform steps 530 and 535 of the method 500 of FIG. 5A. The method 550 may be performed by the computer 110 and/or the processor 405 of the computer 110.

The method 550 starts, and in one embodiment, the processor 405 determines 555 the protected video content 207 in the review content 255. The processor 405 may determine 555 each segment of the protected video content 207 in the review content 255 and record the segments to the protected content indicator 263. In addition, the processor 405 may determine 555 the percentage of the protected video content 207 in the review content 255 and record the percentage to the protected content indicator 263. In one embodiment, the processor 405 determines 555 the percentage of the review content 255 that is protected video content 207 and records the percentage to the protected content indicator 263. The processor 405 may similarly determine 555 the protected video promotions 211 in the review content 255 and record the promotional content indicator 265. In addition, the processor 405 may similarly determine 555 the protected extra content 215 in the review content 255 and record the extra content indicator 267.

The processor 405 may further determine 560 the protected audio content 209 in the review content 255. In one embodiment, the processor 405 determines 560 each segment of the protected audio content 209 in the review content 255 and records the segments to the protected content indicator 263. The processor 405 may also determine 560 the percentage of the protected audio content 209 in the review content 255 and record the percentage to the protected content indicator 263. In addition, the processor 405 may determine 560 the percentage of the review content 255 that is protected audio content 209 and record the percentage to the protected content indicator 263. The processor 405 may similarly determine 560 the protected audio promotions 213 in the review content 255 and record the promotional content indicator 265.

The processor 405 may determine 565 the submitter video content in the review content 255. The processor 405 may determine 565 each segment of the submitter video content in the review content 255 and record the segments to the submitter video content indicator 277. In one embodiment, the submitter video content is any video portion of the review content 255 that is not the protected video content 207, protected video promotions 211, and/or video protected extra content 215. In addition, the processor 405 may determine 565 the percentage of the submitter video content in the review content 255 and record the percentage to the submitter video content indicator 277. In one embodiment, the processor 405 determines 565 the percentage of the review content 255 that is submitter video content and records the percentage to the submitter video content indicator 277.

The processor 405 may determine 570 the submitter audio content in the review content 255. The processor 405 may determine 570 each segment of the submitter audio content in the review content 255 and record the segments to the submitter audio content indicator 279. In one embodiment, the submitter audio content is any audio portion of the review content 255 that is not the protected audio content 209, protected audio promotions 213, and/or audio protected extra content 215. In addition, the processor 405 may determine 570 the percentage of the submitter audio content in the review content 255 and record the percentage to the submitter audio content indicator 279. In one embodiment, the processor 405 determines 570 the percentage of the review content 255 that is submitter audio content and records the percentage to the submitter audio content indicator 279.

The determination of both video and audio elements of the protected content video 208, promotional content 212, protected extra content 215, and submitter content supports a more nuanced determination of the review content disposition 250. As a result, video elements and/or audio elements may be used separately and in combination to determine the review content disposition 250.

The processor 405 may traverse 575 the decision threshold hierarchy 125 and the method 550 ends. In one embodiment, the processor 405 identifies a highest decision threshold 450 in the decision threshold hierarchy 125 and determines which of the plurality of threshold priorities 455/459/457/463/467/471 for the decision threshold 450, including the monetization threshold priority 455, the blocking threshold priority 459, the tracking threshold priority 463, the takedown threshold priority 467, and the archive threshold priority 479, has the highest priority. The processor 405 may further determine if the corresponding threshold is satisfied. If the corresponding threshold 453/457/461/465/469 is satisfied, the processor 405 performs the corresponding action 456/460/464/468/472. In one embodiment, the corresponding action 456/460/464/468/472 specifies the review content disposition 250. Alternatively, the corresponding action 456/460/464/468/472 may specify another threshold in the current decision threshold 450 or a child decision threshold 450. The processor 405 may subsequently traverse 575 the other threshold 453/457/461/465/469 or the child decision threshold 450. Thus, the processor 405 may traverse 575 the decision threshold hierarchy 125 until the review content disposition 250 is generated. In one embodiment, the processor 405 does not traverse thresholds 453/457/461/465/469 with a corresponding NULL priority.

In one embodiment, the protected content profile 260 includes a promotional content indicator 263. In addition, a first decision threshold 450 may include a monetization threshold 453 with a non-NULL monetization threshold priority 455 that is a highest priority for the first decision threshold 450.

In an alternative embodiment, the protected content profile 260 includes one or more of the submitter video content indicator 277 and the submitter audio content indicator 279. In addition, one of the monetization threshold for 453, the blocking threshold 457, the tracking threshold 461, takedown threshold 465, and the archive threshold 469 may include one or more of the submitter video content threshold 361 and the video audio content threshold 363.

In a certain embodiment, the protected content profile 260 includes one or more of the still image indicator 281, the partner channel indicator 285, and the fair use indicator 287. In addition, one of the monetization threshold for 453, the blocking threshold 457, the tracking threshold 461, takedown threshold 465, and the archive threshold 469 may include one or more of the still image threshold 373, the partner channel threshold 379, and the fair use threshold 381.

In one embodiment, the protected content profile 260 includes one or more of the extra content indicator, the duplicate content indicator 269, the modified content indicator 271, the complete content indicator 267, the trailer content indicator 275, and a promotional content indicator 265. In addition, one of the monetization threshold for 453, the blocking threshold 457, the tracking threshold 461, takedown threshold 465, and the archive threshold 469 may include one or more of the promotional content threshold 357, the extra content threshold 383, the duplicate content threshold 385, the modified content threshold 387, the complete content threshold 389, the trailer content threshold 391, Other combinations of the protected content profile 260 and the decision threshold 450 may be employed without limit.

FIGS. 6A-D are a schematic flow chart diagram illustrating one embodiment of a review method 600. The review method 600 may calculate the review content disposition 250. In one embodiment, the review method 600 perform step 535 of the method 500 of FIG. 5A. The method 600 may be performed by the computer 110 and/or the processor 405 of the computer 110.

The method 600 starts, and in one embodiment, the processor 405 determines 601 if the review content 255 includes promotional content 212. The processor 405 may determine 601 that the review content 255 includes promotional content 212 from the promotional content indicator 265.

If the review content 255 includes the promotional content 212, the processor 405 determines 621 if the promotional content indicator 265 exceeds the promotional content threshold 357. If the promotional content indicator 265 does not exceed the promotional content threshold 357, the review content disposition 250 is to monetize 623 the review content 255 by providing advertising with the review content 255 on the content host 105 and the method 600 ends. If the promotional content indicator 265 exceeds the promotional content threshold 357, the processor 405 determines 625 if the protected content indicator 263 exceeds one or more of the protected video content threshold 353 and the protected audio content threshold 355. If the protected content indicator 263 does not exceed one or more of the protected video content threshold 353 and the protected audio content threshold 355, the review content disposition 250 is to archive 627 the review content 255 and the method 600 ends. If the protected content indicator 263 exceeds one or more of the protected video content threshold 353 and the protected audio content threshold 355, the review content disposition 250 is to block 629 the review content 255 by communicating a request to block the review content 255 to the content host 105 and the method 600 ends.

If the review content 255 does not include promotional content 212, the processor 405 determines 603 if the review content 255 includes protected content 208. In one embodiment, the review content 255 includes protected content 208 if the protected content indicator 263 is not NULL.

If the review content 255 does not include protected content 208, the review content disposition 250 is to archive 611 the review content 255 and the method 600 ends. If the review content 255 includes protected content 208, the processor 405 determines 607 whether the still image indicator 281 exceeds the still image threshold 373. If the still image indicator 281 exceeds the still image threshold 373, the processor 405 determines 641 if review content 255 linked to the still image of the still image indicator 281 is relevant to the protected content 208. If the review content 255 linked to the still image is relevant to the protected content 208, the review content disposition 250 is to archive 643 the review content 255 and the method 600 ends. If the review content 255 linked to the still image is not relevant to the protected content 208, the review content disposition 250 is to block 645 the review content 255 by communicating a request to block the review content 255 to the content host 105 and the method 600 ends.

If the still image indicator 281 does not exceed the still image threshold 373, the processor 405 determines 607 if the protected content 208 exceeds one or more of the protected video content threshold 353 and the protected audio content threshold 355. In one embodiment, the processor 405 compares the protected content indicator 263 to one or more of the protected video content threshold 353 and the protected audio content threshold 355. The review content 255 may satisfy the comparison if the protected content indicator 263 exceeds one or more of the protected video content threshold 353 and the protected audio content threshold 355. If the protected content 208 does not exceed one or more of the protected video content threshold 353 and the protected audio content threshold 355, the review content disposition 250 is to archive 611 the review content 255 and the method 600 ends.

If the protected content 208 exceeds one or more of the protected video content threshold 353 and the protected audio content threshold 355, the processor 405 may determine 609 if the review content 255 includes submitter content and/or modified content. In one embodiment, the processor 405 determine 609 that the review content 255 includes submitter content and/or modified content if the modified content indicator 271, the submitter video content indicator 277, and/or the submitter audio content indicator 279 is not NULL.

If the review content 255 does not include submitter content and/or modified content, the review content disposition 250 is to block 613 the review content 255 by communicating a request to block the review content 255 to the content host 105 and the method 600 ends.

If the review content 255 includes submitter content and/or modified content, the processor 405 may determine 661 if the review content 255 includes protected speech. In one embodiment, the processor 405 determine 661 that the review content 255 includes protected speech if the fair use indicator 287 exceeds the fair use threshold 381.

If the review content 255 does not include protected speech, the processor 405 may determine 663 if the review content 255 includes modified content. The processor 405 may determine 663 that the review content 255 includes modified content if the modified content indicator 271 exceeds the modified content threshold 387.

If the review content 255 does not include modified content, the processor 405 may determine 665 if the review content 255 includes submitter content. In one embodiment, the processor 405 determine 665 that the review content 255 includes added content if the submitter video content indicator 277 and/or the submitter audio content indicator 279 in not NULL.

If the review content 255 does not include submitter content, the processor 405 may determine 667 if the review content 255 includes critical content. The processor 405 may determine 667 that the review content 255 includes critical content if the review indicator 283 exceeds one of the review video threshold 375 and the review audio threshold 377. If the review content 255 does not include critical content, the review content disposition 250 may be to take down 669 the review content 255 by communicating a takedown request for the review content 255 to the content host 105 and the method 600 ends.

If the review content 255 includes protected speech, or includes modified content, or includes added content, or includes critical content, the review content disposition 250 may be to track 671 the review content 255 and the method 600 ends. The method 600 illustrates one embodiment of traversing the decision threshold hierarchy 125 with the protected content profile 260.

The embodiments disclosed herein automate the review of content from a content host 105 by calculating the review content disposition 250 as a disposition function of the protected content profile 260 and the decision threshold hierarchy 125 for a given owner of protected content 208. The embodiments support the analysis of large number of review content instances 255 that would be impractical for human reviewers to process. As a result, the embodiments allow the owners of protected content 208 to identify, review, and take appropriate actions for all content on the content host 105 that includes the protected content 208.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method comprising:
identifying, by use of a processor, review content from a content host that provides online submitter posted content;
recording the content host;
identifying jurisdictions for the review content;
analyzing the review content for protected content;
identifying the protected content in the review content;
in response to identifying protected content in the review content, determining a protected content profile comprising protected video content and protected audio content for the review content;
calculating a review content disposition as a disposition function of the protected content profile and a decision threshold hierarchy for an owner of the protected content, wherein a decision threshold of the decision threshold hierarchy comprises a protected video content threshold and a protected audio content threshold, and the review content disposition is selected from the group consisting of monetizing the review content on the content host, communicating a request to block the review content to the content host, tracking views of the review content on the content host, communicating a takedown request for the review content to the content host, and archiving the review content; and
executing the review content disposition.

2. The method of claim 1, the method further calculating a Transmission Control Protocol (TCP) window size and TCP window scaling as a function of the protected video content.

3. The method of claim 1, wherein the decision threshold hierarchy comprises one or more decision thresholds organized in one or more parent/child relationships and each decision threshold comprises a parent decision threshold, a monetization threshold, a monetization threshold priority, a blocking threshold, a blocking threshold priority, a tracking threshold, a tracking threshold priority, a takedown threshold, a takedown threshold priority, an archive threshold, and an archive threshold priority.

4. The method of claim 3, wherein determining the protected content profile comprises:
determining submitter video content in the review content;
determining submitter audio content in the review content; and
traversing the decision threshold hierarchy based on the plurality of threshold priorities for the decision thresholds.

5. The method of claim 4, wherein the protected content profile further comprises a promotional content indicator, and the monetization threshold comprises the promotional video content threshold.

6. The method of claim 4, wherein the protected content profile further comprises one or more of a submitter video content indicator and a submitter audio content indicator, and one of the monetization threshold, the blocking threshold, the tracking threshold, and takedown threshold, and the archive threshold comprises one or more of submitter video content threshold and a submitter audio content threshold.

7. The method of claim 4, wherein the protected content profile further comprises one or more of a still image indicator, a partner channel indicator, and a fair use indicator, and one of the monetization threshold, the blocking threshold, the tracking threshold, and takedown threshold, and the archive threshold comprises one or more of a still image threshold, a partner channel threshold, and a fair use threshold.

8. The method of claim 4, wherein the protected content profile further comprises one or more of an extra content indicator, a duplicate content indicator, a modified content indicator, a complete content indicator, a trailer content indicator, and a promotional content indicator, and one of the monetization threshold, the blocking threshold, the tracking threshold, and takedown threshold, and the archive threshold comprises one or more of a promotional content threshold, an extra content threshold, a duplicate content threshold, a modified content threshold, a complete content threshold, and a trailer content threshold.

9. A program product comprising a computer readable storage medium that stores code executable by a processor, the executable code comprising code to perform:
identifying review content from a content host that provides online submitter posted content;
recording the content host;
identifying jurisdictions for the review content;
analyzing the review content for protected content;
identifying the protected content in the review content;
in response to identifying protected content in the review content, determining a protected content profile comprising protected video content and protected audio content for the review content;
calculating a review content disposition as a disposition function of the protected content profile and a decision threshold hierarchy for an owner of the protected content, wherein a decision threshold of the decision threshold hierarchy comprises a protected video content threshold and a protected audio content threshold, and the review content disposition is selected from the group consisting of monetizing the review content on the content host, communicating a request to block the review content to the content host, tracking views of the review content on the content host, communicating a takedown request for the review content to the content host, and archiving the review content; and
executing the review content disposition.

10. The program product of claim 9, wherein the decision threshold hierarchy comprises one or more decision thresholds organized in one or more parent/child relationships and each decision threshold comprises a parent decision threshold, a monetization threshold, a monetization threshold priority, a blocking threshold, a blocking threshold priority, a tracking threshold, a tracking threshold priority, a takedown threshold, a takedown threshold priority, an archive threshold, and an archive threshold priority.

11. The program product of claim 10, wherein determining the protected content profile comprises:
determining submitter video content in the review content;
determining submitter audio content in the review content; and
traversing the decision threshold hierarchy based on the plurality of threshold priorities for the decision thresholds.

12. The program product of claim 11, wherein the protected content profile further comprises a promotional content indicator, and the monetization threshold comprises the promotional video content threshold.

13. The program product of claim 11, wherein the protected content profile further comprises one or more of a submitter video content indicator and a submitter audio content indicator, and one of the monetization threshold, the blocking threshold, the tracking threshold, and takedown threshold, and the archive threshold comprises one or more of submitter video content threshold and a submitter audio content threshold.

14. The program product of claim 11, wherein the protected content profile further comprises one or more of a still image indicator, a partner channel indicator, and a fair use indicator, and one of the monetization threshold, the blocking threshold, the tracking threshold, and takedown threshold, and the archive threshold comprises one or more of a still image threshold, a partner channel threshold, and a fair use threshold.

15. The program product of claim 11, wherein the protected content profile further comprises one or more of an extra content indicator, a duplicate content indicator, a modified content indicator, a complete content indicator, a trailer content indicator, and a promotional content indicator, and one of the monetization threshold, the blocking threshold, the tracking threshold, and takedown threshold, and the archive threshold comprises one or more of a promotional content threshold, an extra content threshold, a duplicate content threshold, a modified content threshold, a complete content threshold, and a trailer content threshold.

16. An apparatus comprising:
a processor;
a memory storing code executable by the processor to perform:
identifying review content from a content host that provides online submitter posted content;
recording the content host;
identifying jurisdictions for the review content;
analyzing the review content for protected content;
identifying the protected content in the review content;
in response to identifying protected content in the review content, determining a protected content profile comprising protected video content and protected audio content for the review content;
calculating a review content disposition as a disposition function of the protected content profile and a decision threshold hierarchy for an owner of the protected content, wherein a decision threshold of the decision threshold hierarchy comprises a protected video content threshold and a protected audio content threshold, and the review content disposition is selected from the group consisting of monetizing the review content on the content host, communicating a request to block the review content to the content host, tracking views of the review content on the content host, communicating a takedown request for the review content to the content host, and archiving the review content; and
executing the review content disposition.

17. The apparatus of claim 16, wherein the decision threshold hierarchy comprises one or more decision thresholds organized in one or more parent/child relationships and each decision threshold comprises a parent decision threshold, a monetization threshold, a monetization threshold priority, a blocking threshold, a blocking threshold priority, a tracking threshold, a tracking threshold priority, a takedown threshold, a takedown threshold priority, an archive threshold, and an archive threshold priority.

18. The apparatus of claim 17, wherein determining the protected content profile comprises:
determining submitter video content in the review content;
determining submitter audio content in the review content; and
traversing the decision threshold hierarchy based on the plurality of threshold priorities for the decision thresholds.

19. The apparatus of claim 18, wherein the protected content profile further comprises a promotional content indicator, and the monetization threshold comprises the promotional video content threshold.

20. The apparatus of claim 18, wherein the protected content profile further comprises one or more of a submitter video content indicator and a submitter audio content indicator, and one of the monetization threshold, the blocking threshold, the tracking threshold, and takedown threshold, and the archive threshold comprises one or more of submitter video content threshold and a submitter audio content threshold.
